(19) United States
(12) Patent Application Publication
(10) Pub. No.: US 2015/0269665 A1
(43) Pub. Date: Sep. 24, 2015

(54) Automated Documentation System and Method

(71) Applicants: Michael John Mackie, Wellington (NZ); Daniel James McInteer, Wellington (NZ)

(72) Inventors: Michael John Mackie, Wellington (NZ); Daniel James McInteer, Wellington (NZ)

(21) Appl. No.: 14/633,010

(22) Filed: Feb. 26, 2015

(30) Foreign Application Priority Data
Feb. 26, 2014 (NZ) 621779

(51) Int. Cl. G06Q 40/00; G06Q 10/10

(52) U.S. Cl. CPC G06Q 40/00; G06Q 10/10

(57) ABSTRACT

An automated documentation system includes a data model manager that maintains at least one object model having a plurality of object classes; an interpretation module that populates the object classes of the data model from at least one source file; a persist module that generates at least one persisted object model associated to the or a respective one of the object models, the at least one object model having a plurality of tables and relationships between the tables, and maintain the at least one persisted object model in a data store, the data store having a plurality of stored persisted object models; and a compare module that compares two persisted object models by comparing at least one of the objects common to the persisted object models, and store a representation of differences identified in the at least one common object in one or both of the two persisted object models.

### CROSS-REFERENCE TO RELATED APPLICATIONS

This application claims the benefit of New Zealand application 621779, filed on Feb. 26, 2014, which is incorporated by reference herein in its entirety.

### FIELD

The described embodiments relate to providing model analyses and automated generation of documentation solutions.

### BACKGROUND

Finance departments often lack appropriate systems and support to carry out vital reporting functions. Strategy support, enterprise performance management and risk management activities can be compromised because finance departments are too busy reining in and validating data. They rely on systems, ranging from spreadsheets to ERP solutions, that are disconnected, expensive, completely managed by IT, and lack the performance and data reliability essential for on-demand analytics.

Various tools exist to assist finance departments. One such product is the IBM Cognos® TM1® product. As a planning solution, it provides immediate visibility into resource requirements and future business performance. It provides “what-if” scenario analytics for all participants and facilitates decision-making throughout the enterprise. The product provides distributed administrative capabilities, thereby enabling localized responsibility for plan processes across business units, functions and geographies.

Understanding and documenting existing IBM® Cognos® TM1® models can be a time-consuming process. Further, when making changes to complex models, it is challenging to fully understand the implications of these changes to ensure issues or inaccuracies won't arise. Having made the changes, documentation must be also updated thereby incurring effort better spent on creating new models or analyzing the resultant data.

### SUMMARY

It is an object of preferred embodiments to address some of the aforementioned disadvantages. An additional or alternative object is to at least provide the public with a useful choice.

One embodiment comprises an automated documentation system comprising a data model manager configured to maintain, on a computer-readable medium, at least one object model, the at least one object model having a plurality of object classes; an interpretation module configured to populate the object classes of the at least one data model from at least one source file maintained on a computer-readable medium; a persist module configured to: generate at least one persisted object model associated to the or a respective one of the at least one object model, the at least one object model having a plurality of tables and relationships between the tables, and maintain the at least one persisted object model in a data store maintained on a computer-readable medium, the data store having a plurality of stored persisted object models; and a compare module configured to: compare two persisted object models by comparing at least one of the objects common to the persisted object models, and store a representation of differences identified in the at least one common object in one or both of the two persisted object models.

In one embodiment the persist module is configured to map at least one of the object classes in the at least one object model to the plurality of tables and relationships in the persisted object model.

In one embodiment at least one of the plurality of tables comprises a set of attributes and/or columns associated to respective properties of the object model.

In one embodiment the system further comprises a serialiser module configured to generate at least one serialised object model represented in a data-interchange format from the at least one persisted object model for input to a presentation module.

In one embodiment the data-interchange format is selected from one or more of JavaScript Object Notation and Extensible Markup Language.

In one embodiment the data-interchange format comprises a plain text representation of the at least one persisted object model.

In one embodiment at least one of the persisted object models includes a unique timestamp, the serialised object model representing a version of the persisted object model associated to the serialised object model at the unique timestamp.

In one embodiment the compare module is configured to receive a user selection of a first user-readable documentation at a first timestamp and a second user-readable documentation at a second timestamp.

In another aspect, a method of automating documentation creation comprises maintaining, on a computer-readable medium, at least one object model, the at least one object model having a plurality of object classes; populating at least one object class of the at least one object model from at least one source file maintained on a computer-readable medium; generating at least one persisted object model associated to the or a respective one of the at least one object model, the at least one object model having a plurality of tables and relationships between the tables; maintaining the at least one persisted object data model in a data store maintained on a computer-readable medium, the data store having a plurality of stored persisted object models; comparing two persisted object models by comparing at least one of the objects common to the persisted object models; and storing a representation of differences identified in the at least one common object in one or both of the two persisted object models.

In one embodiment the method further comprises mapping at least one of the object classes in the at least one object model to the plurality of tables and relationships in the persisted object model.

In one embodiment at least one of the plurality of tables comprises a set of attributes and/or columns associated to respective properties of the object model.

In one embodiment the method further comprises generating at least one serialised object model represented in a data-interchange format from the at least one persisted object model for input to a presentation module.

In one embodiment the data-interchange format is selected from one or more of JavaScript Object Notation and Extensible Markup Language.

In one embodiment the data-interchange format comprises a plain text representation of the at least one persisted object model.

In one embodiment at least one of the persisted object models includes a unique timestamp, the serialised object model representing a version of the persisted object model associated to the serialised object model at the unique timestamp.

In one embodiment the method further comprises receiving a user selection of a first user-readable documentation at a first timestamp and a second user-readable documentation at a second timestamp.

In another aspect a tangible, non-transitory computer readable medium has stored thereon computer executable instructions that, when executed by a processor, cause the processor to perform the method described above.

In a further aspect, an automated documentation system comprises a display; a processor; and a computer readable medium having stored thereon computer executable instructions that, when executed by the processor, cause the processor to perform the method described above.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

In addition, where features or aspects of the invention are described in terms of Markush groups, those persons skilled in the art will appreciate that the invention is also thereby described in terms of any individual member or subgroup of members of the Markush group.

As used herein, ‘(s)’ following a noun means the plural and/or singular forms of the noun.

As used herein, the term ‘and/or’ means ‘and’ or ‘or’ or both.

The term “connected to” includes all direct or indirect types of communication, including wired and wireless, via a cellular network, via a data bus, or any other computer structure. It is envisaged that they may be intervening elements between the connected integers.

Variants such as “in communication with”, “joined to”, and “attached to” are to be interpreted in a similar manner.

The term “computer-readable medium” should be taken to include a single medium or multiple media. Examples of multiple media include a centralised or distributed database and/or associated caches. These multiple media store the one or more sets of computer executable instructions. The term “computer readable medium” should also be taken to include any medium that is capable of storing, encoding or carrying a set of instructions for execution by a processor and that cause the processor to perform any one or more of the methods described above. The computer-readable medium is also capable of storing, encoding or carrying data structures used by or associated with these sets of instructions. The term “computer-readable medium” includes solid-state memories, optical media (including CD-Rom, DVD-Rom, and Blu-Ray) and magnetic media.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9, and 10) and also any range of rational numbers within that range (for example, 2 to 8, 1.5 to 5.5, and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

In this specification where reference has been made to patent specifications, other external documents, or other sources of information, this is generally for the purpose of providing a context for discussing the features of the invention. Unless specifically stated otherwise, reference to such external documents or such sources of information is not to be construed as an admission that such documents or such sources of information, in any jurisdiction, are prior art or form part of the common general knowledge in the art.

Although the present invention is broadly as defined above, those persons skilled in the art will appreciate that the invention is not limited thereto and that the invention also includes embodiments of which the following description gives examples.

### BRIEF DESCRIPTION OF THE DRAWINGS

Preferred forms of the automated documentation system and method will now be described by way of example only with reference to the accompanying figures in which:

FIG. 1 shows a preferred form automated documentation system in accordance with the invention;

FIG. 2 shows a simplified block diagram of a device forming at least part of a computing device and/or server from FIG. 1;

FIG. 3 shows a simplified block diagram of the system architecture;

FIG. 4 shows a preferred form Manage Versions interface;

FIG. 5 shows a compare versions interface;

FIG. 6 shows a preferred form change detection summary report;

FIGS. 7 and 8 shows a preferred form process change detection report;

FIG. 9 illustrates a compare versions interface;

FIG. 10 shows a change detection summary report; and

FIGS. 11 and 12 shows a preferred form process change detection report.

### DETAILED DESCRIPTION

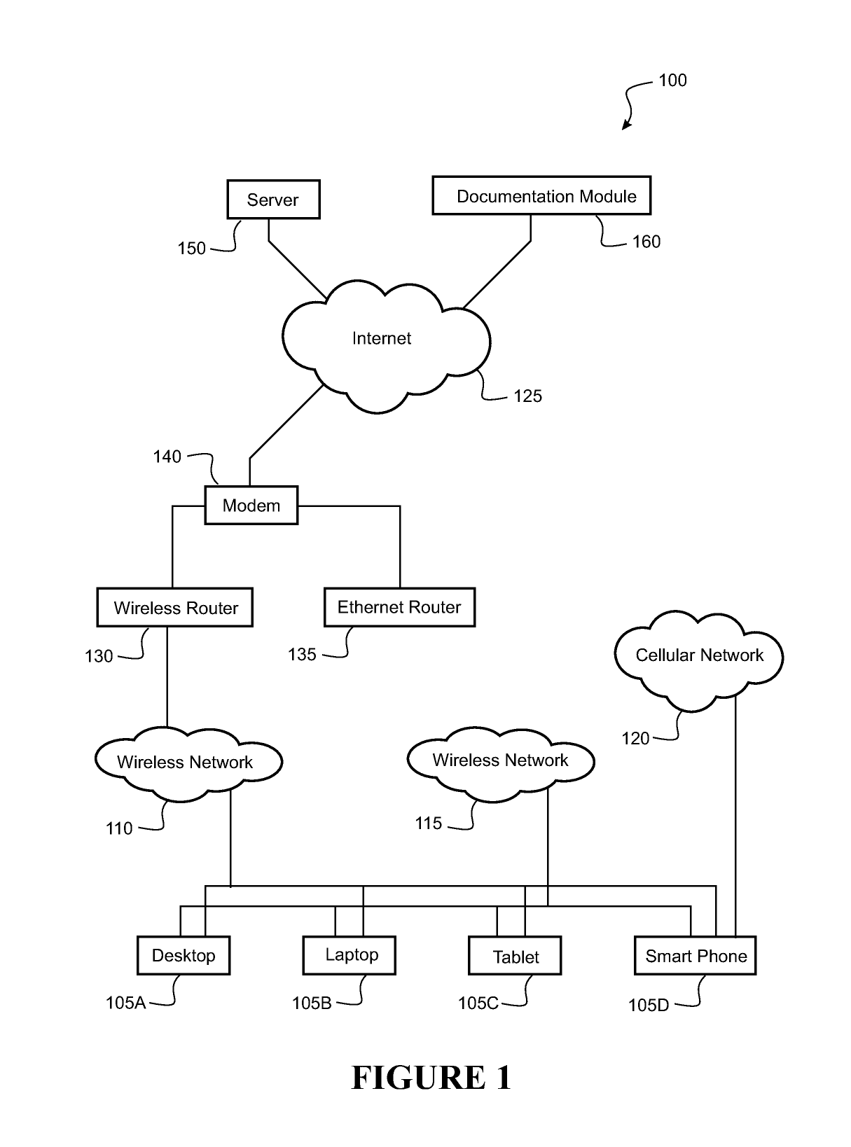

FIG. 1 shows a preferred form automated documentation system 100.

The user of system 100 typically operates one or more computing devices. The computing devices typically comprise a general-purpose programming device such as a desktop 105A, laptop 105B, tablet 105C or smart phone 105D. In an embodiment, computing devices 105_{A-D} operate under control of respective client modules to perform the techniques described below. Client modules preferably comprise computer-executable instructions that cause computing devices 105_{A-D} to perform various functions.

Computing devices 105_{A-D} are connected to at least one network. Preferred form networks include wireless network 110, wireless network 115, cellular network(s) 120, and the internet 125. Wireless network 110 is preferably located within a user premises for example a residential or commercial building. Wireless network 110 is typically a private network intended for private use of the applicant or investor. Alternatively, wireless network 110 comprises a public network provided for the use of customers of an educational institution, accommodation provider, library or cafe.

Wireless network 115 is typically a wireless hotspot or Bluetooth pairing generated at least partly by tablet 105_{C} or smart phone 105_{D}.

Desktop 105_{A} for example in one configuration is connected to the internet 125 through a wired connection to wireless router 130 and/or Ethernet router 135. Routers 130 and/or 135 are connected to modem 140 to permit connectivity to the internet 125.

In another configuration the desktop 105_{A} is connected to wireless router 130 via the wireless network 110 generated by wireless router 130.

In a further configuration the desktop 105_{A} is physically connected to modem 140.

Alternatively or additionally desktop 105_{A} is connected to the internet 125 via cellular network(s) 120 and tablet 105_{C} and/or smartphone 105_{D}. Desktop 105_{A} is physically connected to tablet 105_{C} and/or smartphone 105_{D}. Alternatively or additionally desktop 105_{A} is wirelessly connected to tablet 105_{C} and/or smartphone 105_{D} via wireless network 115 generated by tablet 105_{C} and/or smartphone 105_{D}.

Laptop 105_{B} in one configuration is connected to the internet 125 through a wired connection to wireless router 130 and/or Ethernet router 135. Routers 130 and/or 135 are connected to modem 140 to permit connectivity to the internet 125.

In another configuration laptop 105_{B} is connected to wireless router 130 via the wireless network 110 generated by wireless router 130.

In a further configuration laptop 105_{B} is physically connected to modem 140.

Alternatively or additionally laptop 105_{B} is connected to the internet 125 via cellular network(s) 120 and tablet 105_{C} and/or smartphone 105_{D}. Laptop 105_{B} is physically connected to tablet 105_{C} and/or smartphone 105_{D}. Alternatively or additionally laptop 105_{B} is wirelessly connected to tablet 105_{C} and/or smartphone 105_{D} via wireless network 115 generated by tablet 105_{C} and/or smartphone 105_{D}.

Tablet 105_{C} and/or smartphone 105_{D} connect to the internet 125 through one or more of the wireless network 110, the wireless network 115, and the cellular network(s) 120.

System 100 further includes a server 150 for example a Cognos TM1 server and a documentation module 160. These features are described further below.

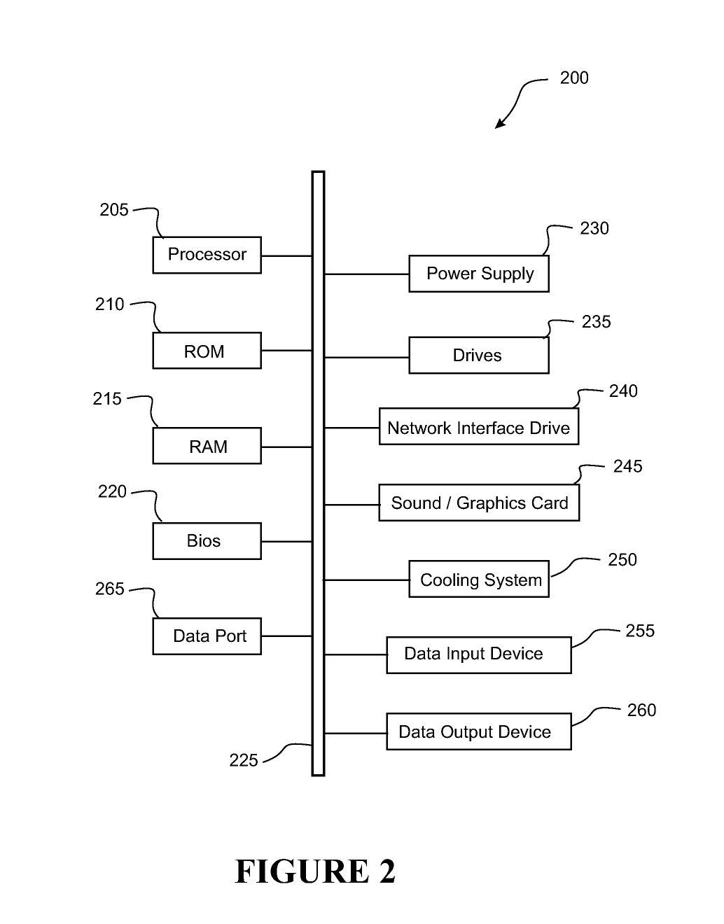

FIG. 2 shows a simplified block diagram of a device forming at least part of computing device 105 and/or server 150 in the example form of a computing device 200.

Sets of computer executable instructions are executed within computing device 200 that cause the device 200 to perform the methods described below. Preferably the computing device 200 is connected to other devices. Where the device is networked to other devices, the device is configured to operate in the capacity of a server or a client machine in a server-client network environment. Alternatively the device can operate as a peer machine in a peer-to-peer or distributed network environment. The device may also include any other machine capable of executing a set of instructions that specify actions to be taken by that machine. These instructions can be sequential or otherwise.

A single device 200 is shown in FIG. 2. The term “computing device” also includes any collection of machines that individually or jointly execute a set or multiple sets of instructions to perform any one or more of the methods described below.

The example computing device 200 includes a processor 205. One example of a processor is a central processing unit or CPU. The device further includes read-only memory (ROM) 210 and random access memory (RAM) 215. Also included is a Basic Input/Output System (BIOS) chip 220. The processor 205, ROM 210, RAM 215 and the BIOS chip 220 communicate with each other via a central motherboard 225.

Computing device 200 further includes a power supply 230 that provides electricity to the computing device 200. Power supply 230 may also be supplemented with a rechargeable battery (not shown) that provides power to the device 200 in the absence of external power.

Also included are one or more drives 235. These drives include one or more hard drives and/or one or more solid state flash hard drives. Drives 235 also include optical drives.

Network interface device 240 includes a modem and/or wireless card that permits the computing device 200 to communicate with other devices. Computing device 200 may also comprise a sound and/or graphics card 245 to support the operation of the data output device 260 described below.

One embodiment of computing device 200 further includes a cooling system 250 for example a heat sink or fan.

Computing device 200 includes one or more data input devices 255. These devices include a keyboard, touchpad, touchscreen, mouse, and/or joystick. The device(s) take(s) input from manual keypresses, user touch with finger(s) or stylus, spoken commands, gestures, and/or movement/orientation of the device.

Data output device(s) 260 include(s) a display and/or printer. Device(s) 260 may further include computer executable instructions that cause the computing device 200 to generate a data file such as a PDF file.

Data port 265 is able to receive a computer readable medium on which is stored one or more sets of instructions and data structures, for example computer software. The software causes the computing device 200 to perform one or more of the methods or functions described below. Data port 265 includes a USB port, Firewire port, or other type of interface.

Software may also reside completely or at least partially within ROM 210, within erasable non-volatile storage and/or within processor 205 during execution by the computing device 200. In this case ROM 210 and processor 205 constitute computer-readable tangible storage media. Software may further be transmitted or received over a network via network interface device 240. The data transfer uses any one of a number of well known transfer protocols. One example is hypertext transfer protocol (http).

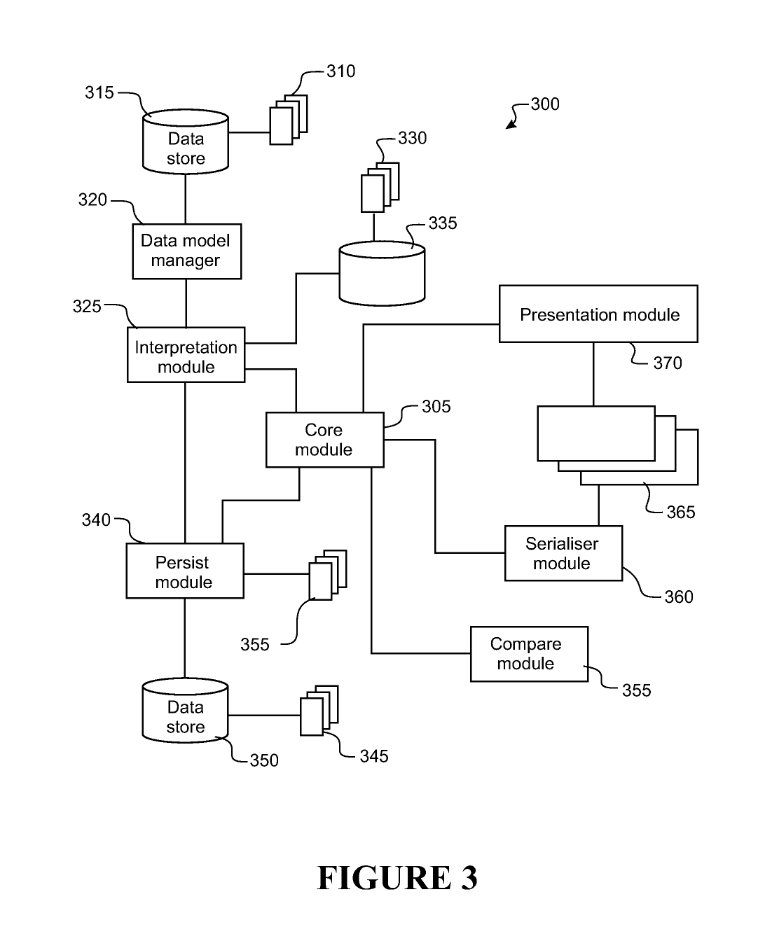

FIG. 3 shows a simplified block diagram of the system architecture 300. A core module 305 is configured to retrieve at least one object model 310. In an embodiment the object model 310 is maintained in a data store 315. A data model manager 320 is configured to maintain the object model 310 within the data store 315 on a computer-readable medium.

The object model 310 has a plurality of object classes. It is intended that these object classes are varied depending on the nature of the data represented. Examples of object classes are further described below.

An interpretation module 325 is configured to populate the object classes of the object model 310 from at least one source file 330 maintained on a computer readable medium 335. In an embodiment the populated object model 310 is maintained in computer readable medium 335 in a transient form before being passed to a persist module (described below) for persistent storage.

A persist module 340 is configured to generate at least one persisted object model 345. In an embodiment the persisted object model 345 is associated to the object model 310. The preferred form persisted object model 345 has a plurality of tables and relationships between the tables.

The persist module 340 is configured to perform an object relationship mapping. This mapping enables a translation of the objects in an object model 310 to tables and relationships in a persisted object model 345.

Module 340 takes as input any given implementation of an object model 310. It constructs a relational table in a data store 350. The relational table has a set of attributes and/or columns that correlate to the properties and relationships held by an object in the object model 310.

Persist module 340 populates the table(s) in the data store 350 based on the object(s) in the object model 345. Properties and relationships are stored as columns in the data store 350 for subsequent retrieval.

A compare module 355 is configured to compare two or more persisted object models 345 by comparing at least one of the objects common to both models. A representation of differences identified in the common object(s) is/are stored in one or both of the persisted object models 345.

A serialiser module 360 is configured to generate at least one serialised object model 365. The model 365 is represented in a data-interchange format and is generated from at least one of the persisted object models 345.

The model 365 is passed to a presentation module 370. Module 370 is configured to interact with the data output device(s) 260 of the computing device 200 of FIG. 2.

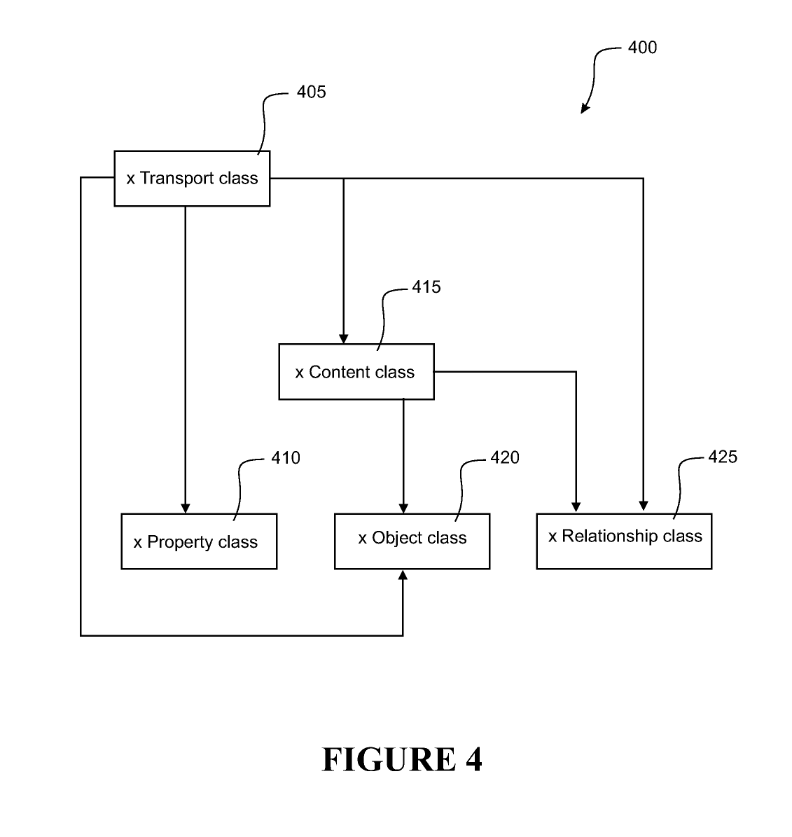

FIG. 4 shows a preferred form core schema 400. One embodiment of the object model 310 is based on the core schema 400. The schema 400 includes a plurality of classes.

Schema 400 includes xTransport class 405. This class provides functional access to the some and preferably all of the other classes within schema 400. One function of class 405 is to provide the ability to read and write an object instance of the schema 400 to or from different languages. Class 405 provides a structure for graphical model 370 to provide a data-interchange format. Examples of suitable data-interchange formats include JavaScript Object Notation (JSON) and Extensible Markup Language (XML).

Examples of attributes of an embodiment of class 405 include one or more of:
Id
LogicalName
CreateClass<T>{ }
<<Properties>>:IList<xProperty>
SetProperty{ }
GetProperty{ }
ToJSON{ }
FromJSON{ }
ToXML{ }
FromXML{ }

Class 405 provides access to xProperty class 410. This class holds supporting attributes and metadata of an object instance of schema 400.

Examples of attributes of an embodiment of class 410 include one or more of:
Id
Key
DataType
Value
Label
Description
AllowSearch:bool
AllowComparison:bool

Class 405 further provides access to xContext class 415. This class provides for a header or version of persisted object model 345.

Examples of attributes of an embodiment of class 415 include one or more of:
Id
Version
Hostname
Description
<<Objects>>:IList<xObject>
<<Relationships>>:IList<xRelationship>
UserCreate
TimeStamp

Class 405 further provides access to xObject class 420. This class is a generic object type. It holds key generic fields used for modelling primary objects. Class 420 also has a direct relationship with class 415.

Examples of attributes of an embodiment of class 420 include one or more of:
Id
Name
LogicalName (Type):string
<<Properties>>:IList<xProperty>
<<Relationships>>:IList<xRelationship>
isInvalid:bool
AllowSort:bool
AllowSearch:bool
AllowConnparison:bool
GenerateDat:datetime
UserCreate:string

Class 405 further provides access to xRelationship class 425. This class is a base class that describes how multiple objects are related to one another and the context in which they are related. Class 425 also has a direct relationship with class 415.

Examples of attributes of an embodiment of class 425 include one or more of:
Id
Source
Target
Type
OrderType
OrderDirection
isOptional:bool
AllowSearch:bool
AllowConnparison:bool

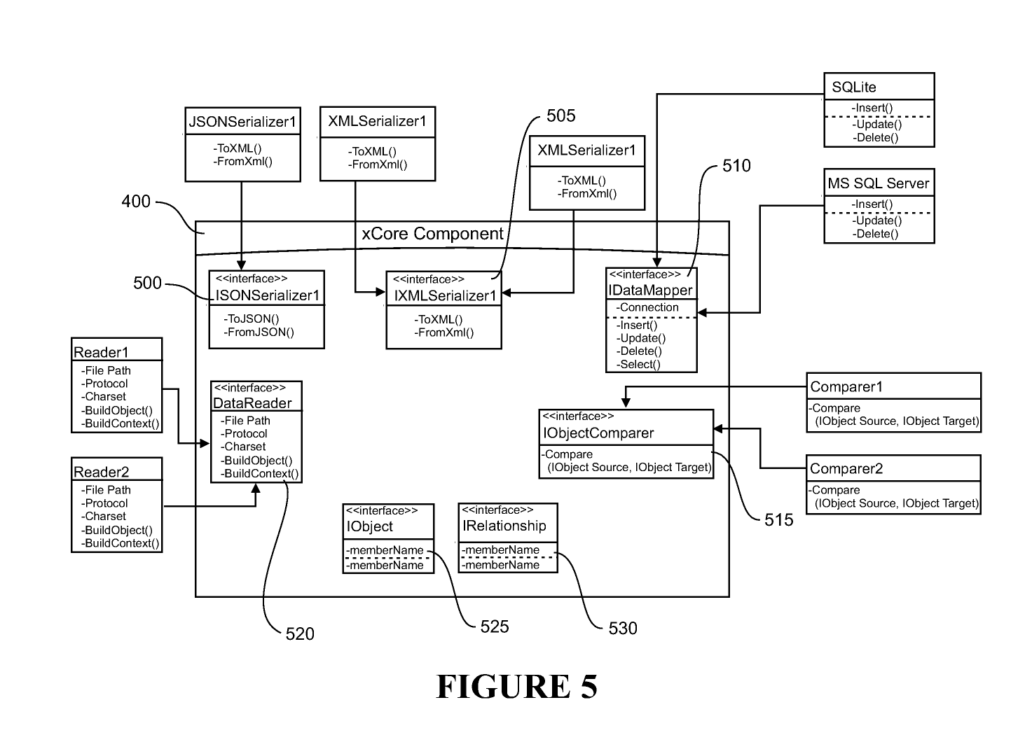

FIG. 5 shows examples of interfaces and implementations relevant to the core schema 400.

The IJSON Serializer interface 500 describes the methods required to serialize an in memory object model 310 to a graphical model 370 in the JSON data format for transfer to downstream components. The implementations of this allows for the graphical model 370 to be represented as JSON and returned to requesting parties, such as REST API requests.

The IXML Serializer interface 505 describes the methods required to serialize an in memory documentation data model 370 to a graphical model 370 in the XML data format for transfer to downstream components. The implementations of this allows for the graphical model 370 to be represented as XML and returned to requesting parties, such as REST API requests.

The IDataMapper interface 510 describes methods that allow for the persist module 340 to persist the documentation data model 370 in to a persisted object model 345, for example a database schema, for storage on disk. Interface 510 includes the ability to store new objects, update exsiting objects, remove objects and read objects. Implementations of this are specific to Database Provider technologies, in the examples specified in the diagram this relates to MS SQL Server and SQLite. However other technologies are envisaged.

The IObjectComparer interface 515 describes methods required by the compare module 355 to implement the comparison between two objects. Preferred form implementations of this interface accept as input two objects and provide a logical comparison of the objects. In an embodiment the interface returns a compared object which can then be serialized using Classes of the IXML Serializer interface 505 to a format conducive to user output.

The IDataReader interface 520 describes methods of reading content in to, or populating, the data model that are required by the interpretation module 325. Interface 520 provides a framework to read objects in the object model 310 from multiple sources. Embodiments of the interface 520 include a data reader from disk, for example reading source files from a hard disk drive and interpreting these to the object model. Other embodiments of the interface 520 include a second reader configured to connect to an upstream API that provides an object model that can be interpreted in to the core schema 400 of FIG. 4.

The IObject interface 525 and IRelationship interface 530 are interfaces for the core object types xObject class 420 and xRelationship class 425 respectively as described in FIG. 4.

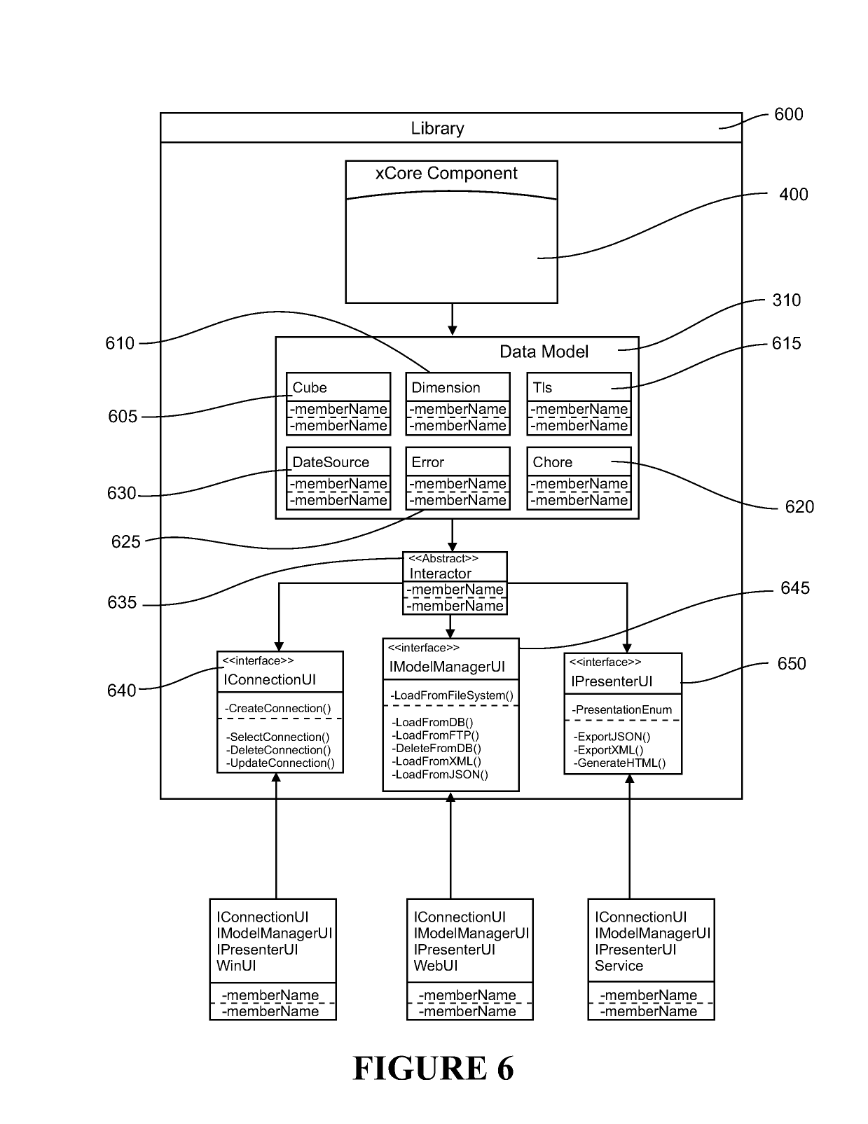

FIG. 6 shows a preferred form data library 600. An embodiment of library 600 comprises the core schema 400, the object model 310 and a set of interfaces that allow for implementation of User Interface controls.

The core schema 400 and associated interfaces are described above with reference to FIGS. 4 and 5.

The object model 310 represents an implementation of the core schema 400 as described in FIG. 4. An embodiment of model 310 includes a plurality of core object types specific to a particular application. In FIG. 6 these are shown as cube 605, dimension 610, TIs 615, chore 620, error 625, and data source 630.

FIG. 6 also shows an abstract Interactor class 635, an Iconnection user interface 640, an IModelManager user interface 645, and an IPresenter user interface 650.

The abstract Interactor Class 635 describes the base functionality of an interactor object and how it communicates with the library 600. User interfaces 640, 645 and 650 inherit from class 635 to describe some base functionality for the library 600 that is expected to be critical to the operation of the system. This base functionality is detailed below.

The IConnection user interface 640 describes the functionality required for a user interface that manages connections to the data model source. This will be used to create, read, update and delete connections which are utilised by the IDataReader classes through the IDataReader interface 520 for connectivity to data model sources.

The IModelManager user interface 645 describes functionality to a user interface layer that allows user interface access to create, read, update and delete data models from different connections as stored in the solution.

The IPresenter user interface 650 describes user interface functions to access the serializer classes through the IXML Serializer interface 505 for serializing to a format that can be transformed to a graphical user interface. An example format is graphical model 370.

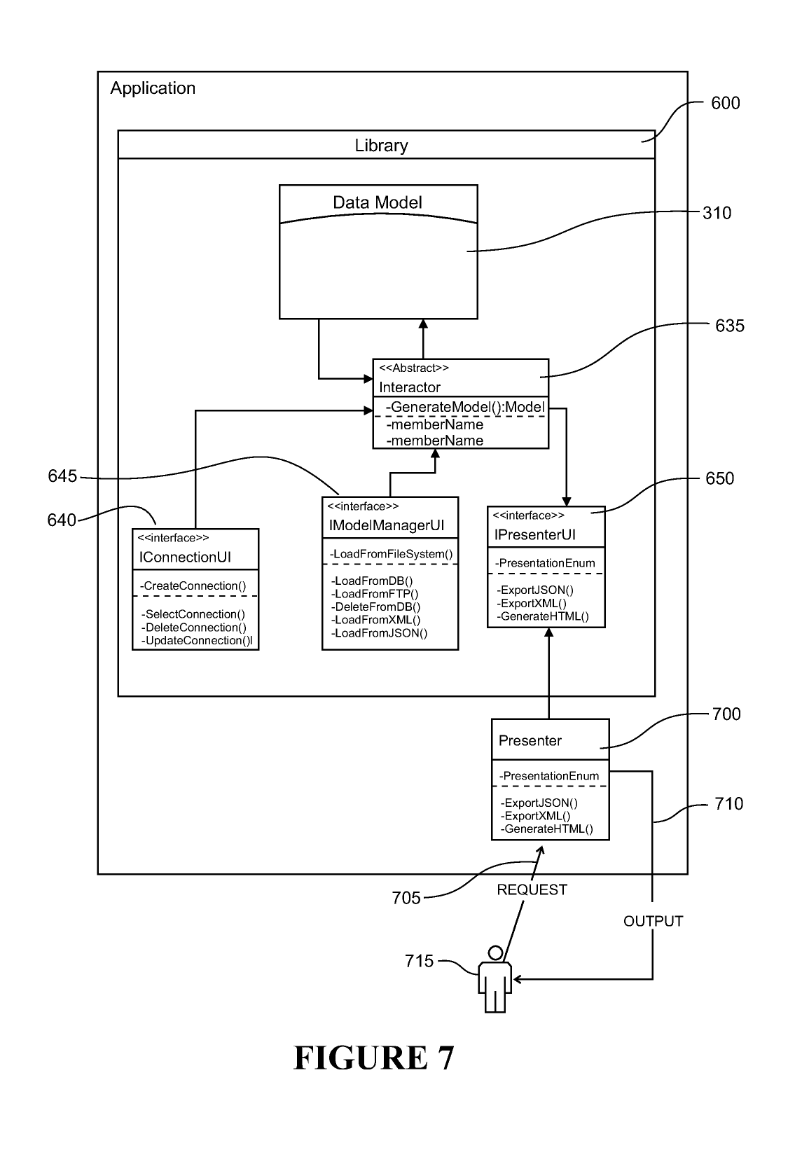

FIG. 7 shows an embodiment of an application implementation of the library 600. The implementation includes documentation data model 310 and user interfaces 635, 640, 645, and 650.

Shown in FIG. 7 is an implementation 700 of the IPresenter user interface 650. The implementation 700 is configured to be called from a user action or user request 705 which results in an output 710 to the end user 715.

In an embodiment, an implementation of the IPresenter user interface 650 comprises a RESTful API Web Service. A user action, for example a click in a browser, loads an HTML template that calls the RESTful API using an AJAX method call. This will return the requested object asynchronously and the HTML template will interpret the returned object and display it to the user 715.

Described below is a model analysis and automated documentation solution for IBM Cognos TM1. The techniques described below enhance Cognos TM1 by adding new dimensions of visibility and governance. There is the potential for a user to manage change with reduced risk and costs.

The preferred form system provides centralized, interactive and up-to-date information to help users effectively develop, administer, maintain and monitor TM1 models. Many of the time-consuming tasks and overheads associated with assessing the impact of changes and trouble-shooting issues that may exist with current models are addressed.

Described below is change detection and versioning features that allow users to retrieve previously generated versions of documentation and overlay these on top of each other to identify what is different over time or between environments. This has the potential to offer significant value for users when trouble-shooting issues, reviewing and documenting changes or migrating changes between environments.

Key questions relevant to users include:
Why is my development environment behaving a certain way when it should be identical to production?
Why was this working last week but is not working now?
Are the required standards being maintained when applying changes to models?

The system persists the documentation generated for a Cognos TM1 server 150 to documentation module 160, which in one form is a light-weight database, so that it can be re-generated on demand. This provides the ability to go back in time and see what a Cognos TM1 model looked like on that day.

In addition to this, it provides for a side-by-side and inline comparison of two versions of documentation. Whether it is a snapshot that has been taken at an earlier date or a comparison between environments, the system reports on the differences that it finds between the two.

Changes are tracked for the following Cognos TM1 objects:
Cubes
Views
Dimensions
Subsets
Rules
Processes
Chores

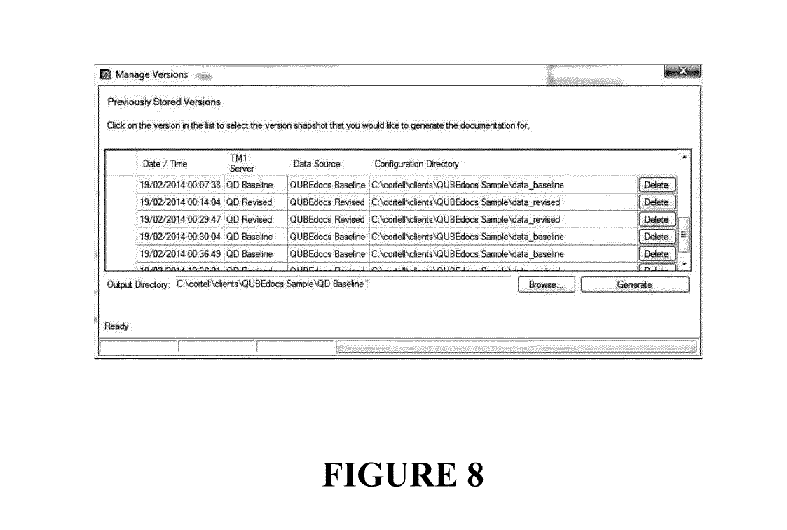

FIG. 8 shows a preferred form Manage Versions interface. The interface allows a user to re-generate previously generated versions of documentation.

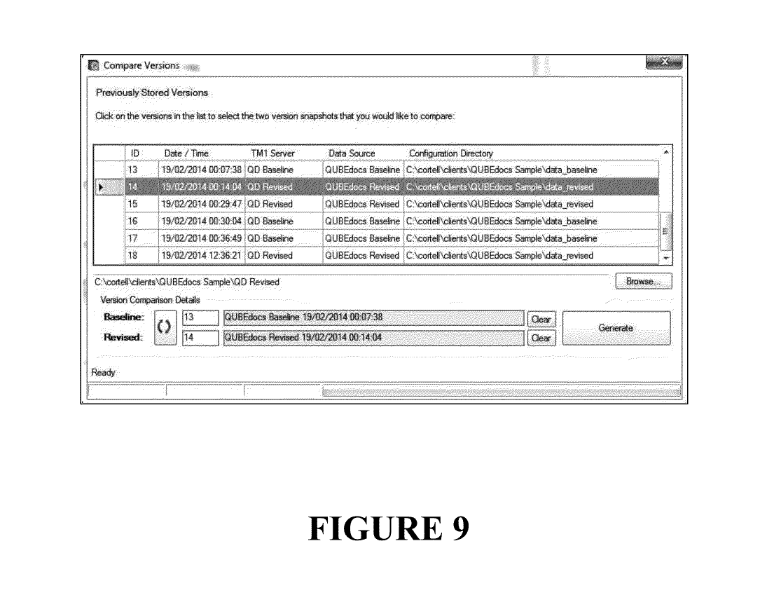

A Compare Versions interface shown in FIG. 9 allows a user to select two versions and view the differences between them.

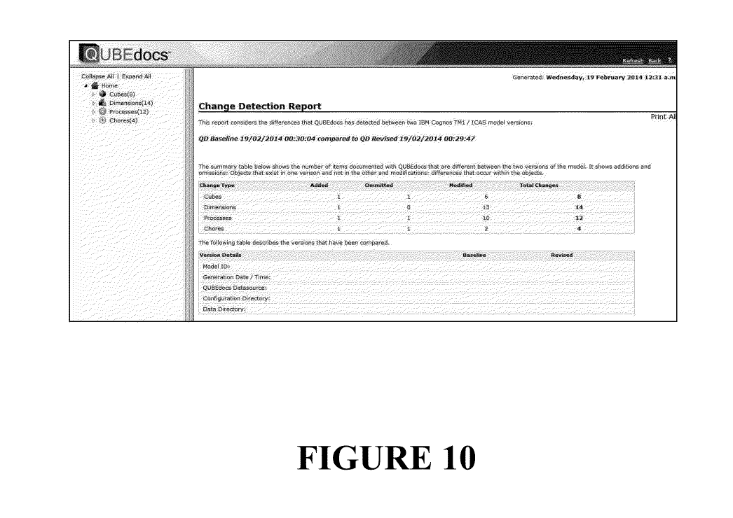

FIG. 10 shows a preferred form Change Detection Summary Report. This report gives an overview of what is different between two versions of the documentation/models.

The detailed change reports are organised by key objects:
Cubes
Views
Dimensions
Subsets
Rules
Processes
Chores

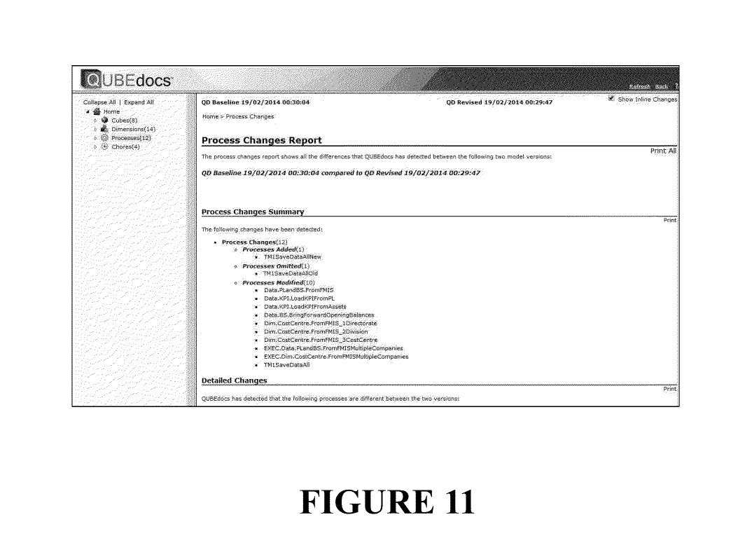

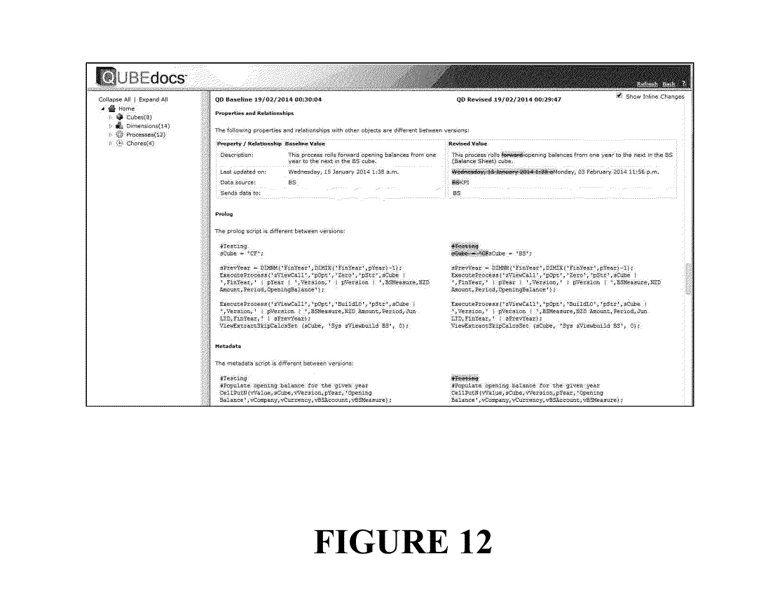

A preferred form Process Change Detection Report is shown in FIGS. 11 and 12.

Further preferred form features include one or more of the following:
Save connections
Version numbers
Enhanced command line operations

Save connections includes the ability to save connections to Cognos TM1 servers for easy access and generation of the documentation

Version Numbers are provided to keep track of documentation snapshots.

Enhanced command line operations provide the ability to generate both model documentation and the change report from within a Cognos TM1 environment or from the command line. Documentation profiles, saved with preferences, can be set. Also set is the connection the user wants to run.

The invention is particularly suitable for taking snapshots of a source file 330 in the form of a database. The snapshots are extracted to a separate medium such as data store 350. The snapshots are stored in a persisted object model 345 for comparison by the compare module 355 and presentation by the presentation module 370.

Rather than performing a direct comparison between two source files 330, an embodiment of the invention extracts information from the two source files and models the data in such a way to enable changes to be compared. The preferred persisted object models 345 have the effect of taking the data outside the systems of source files 330. This has the potential to enable the comparison of a variety of source files and systems automatically.

The interpretation module 325 and compare module 355 work together to compare changes, relationships and dependencies. Modules 325 and 355 generate data that enables the presentation module 370 to show a holistic view of complex systems.

Furthermore the presentation module 370 presents data intuitively. Users are able to drill down and perform a guided analysis. Such an interactive documentation system provides significant advantages over static documents.

The foregoing describes the invention including preferred forms thereof. Modifications and improvements as would be obvious to those skilled in the art are intended to be incorporated in the scope hereof, as defined by the accompanying claims.

1. An automated documentation system comprising:
a data model manager configured to maintain, on a computer-readable medium, at least one object model, the at least one object model having a plurality of object classes;
an interpretation module configured to populate the object classes of the at least one data model from at least one source file maintained on a computer-readable medium;
a persist module configured to:
generate at least one persisted object model associated to the or a respective one of the at least one object model, the at least one object model having a plurality of tables and relationships between the tables, and
maintain the at least one persisted object model in a data store maintained on a computer-readable medium, the data store having a plurality of stored persisted object models; and
a compare module configured to:
compare two persisted object models by comparing at least one of the objects common to the persisted object models, and
store a representation of differences identified in the at least one common object in one or both of the two persisted object models.

2. The system of claim 1 wherein the persist module is configured to map at least one of the object classes in the at least one object model to the plurality of tables and relationships in the persisted object model.

3. The system of claim 2 wherein at least one of the plurality of tables comprises a set of attributes and/or columns associated to respective properties of the object model.

4. The system of claim 1 further comprising a serialiser module configured to generate at least one serialised object model represented in a data-interchange format from the at least one persisted object model for input to a presentation module.

5. The system of claim 4 wherein the data-interchange format is selected from one or more of JavaScript Object Notation and Extensible Markup Language.

6. The system of claim 4 wherein the data-interchange format comprises a plain text representation of the at least one persisted object model.

7. The system of claim 4 wherein at least one of the persisted object models includes a unique timestamp, the serialised object model representing a version of the persisted object model associated to the serialised object model at the unique timestamp.

8. The system of claim 1 wherein the compare module is configured to receive a user selection of a first user-readable documentation at a first timestamp and a second user-readable documentation at a second timestamp.

9. A method of automating documentation creation, the method comprising:
maintaining, on a computer-readable medium, at least one object model, the at least one object model having a plurality of object classes;
populating at least one object class of the at least one object model from at least one source file maintained on a computer-readable medium;
generating at least one persisted object model associated to the or a respective one of the at least one object model, the at least one object model having a plurality of tables and relationships between the tables;
maintaining the at least one persisted object data model in a data store maintained on a computer-readable medium, the data store having a plurality of stored persisted object models;
comparing two persisted object models by comparing at least one of the objects common to the persisted object models; and
storing a representation of differences identified in the at least one common object in one or both of the two persisted object models.

10. The method of claim 9 further comprising mapping at least one of the object classes in the at least one object model to the plurality of tables and relationships in the persisted object model.

11. The method of claim 10 wherein at least one of the plurality of tables comprises a set of attributes and/or columns associated to respective properties of the object model.

12. The method of claim 9 further comprising generating at least one serialised object model represented in a data-interchange format from the at least one persisted object model for input to a presentation module.

13. The method of claim 12 wherein the data-interchange format is selected from one or more of JavaScript Object Notation and Extensible Markup Language.

14. The method of claim 12 wherein the data-interchange format comprises a plain text representation of the at least one persisted object model.

15. The method of claim 12 wherein at least one of the persisted object models includes a unique timestamp, the serialised object model representing a version of the persisted object model associated to the serialised object model at the unique timestamp.

16. The method of claim 9 further comprising receiving a user selection of a first user-readable documentation at a first timestamp and a second user-readable documentation at a second timestamp.

17. A tangible computer readable medium having stored thereon computer executable instructions that, when executed by a processor, cause the processor to perform the method of claim 9.
